(19) United States
(12) Patent Application Publication
(10) Pub. No.: US 2007/0057760 A1
(43) Pub. Date: Mar. 15, 2007

(54) Over-current protection device and manufacturing method thereof

(75) Inventors: Shau Chew Wang, Taipei City (TW); Fu Hua Chu, Taipei City (TW); Yun Ching Ma, Pingtung City (TW)

Correspondence Address: SEYFARTH SHAW LLP, 131 S. DEARBORN ST., SUITE2400, CHICAGO, IL, 60603-5803, US

(73) Assignee: Polytronics Technology Corporation

(21) Appl. No.: 11/448,182

(22) Filed: Jun. 7, 2006

(30) Foreign Application Priority Data
Sep. 15, 2005 (TW) 094131785

(51) Int. Cl. H01C 7/13

(52) U.S. Cl. 338/22 R

(57) ABSTRACT

An over-current protection device comprises a chemically cross-linked positive temperature coefficient (PTC) layer and two electrode foils that can be connected to a power source to allow current to flow through the chemically cross-linked polymeric PTC layer. The chemically cross-linked polymeric PTC layer comprises at least two different PTC polymer layers, and each polymer layer comprises polymer and conductive filler and has a volumetric resistivity between 10⁻¹ and 10⁻³ Ω-cm. The polymer layers have different functional groups and are alternately stacked and hot pressed to generate chemical cross-linking therebetween so as to form the chemically cross-linked polymeric PTC layer, wherein the potential difference of every 0.1 mm in thickness of the chemically cross-linked polymeric PTC layer is less than 30 volts.

### BACKGROUND OF THE INVENTION

(A) Field of the Invention

The present invention is related to an over-current protection device and the manufacturing method thereof, and more specifically, to an over-current protection device with a positive temperature coefficient (PTC) and with high voltage endurance.

(B) Description of the Related Art

The resistance of a positive temperature coefficient (PTC) conductive material is sensitive to temperature variation and can be kept extremely low during normal operation so that the circuit can operate normally. However, if an over-current or an over-temperature event occurs, the resistance will immediately increase to a high resistance state (e.g., above 10⁴ ohm.) Therefore, the over-current will be eliminated and the objective to protect the circuit device will be achieved. Consequently, PTC devices have been commonly integrated into various circuitries so as to prevent damage caused by over-current.

A PTC device usually undergoes a cross-linking treatment to increase the endurances to temperature and voltage. The cross-linking treatment is important to a PTC device that must withstand a voltage higher than 200 volts. Patents U.S. Pat. No. 5,227,946, U.S. Pat. No. 5,195,013, U.S. Pat. No. 5,140,297, U.S. Pat. No. 4,951,382, U.S. Pat. No. 4,955,267, U.S. Pat. No. 4,951,384, U.S. Pat. No. 4,924,074, U.S. Pat. No. 4,907,340, U.S. Pat. No. 4,857,880 and U.S. Pat. No. 4,845,838 disclose PTC devices in which the polymer is irradiated with high dose or several times to enhance the physical and electrical characteristics, thereby enabling the PTC device to withstand high voltages.

However, irradiated polymer easily degrades, and the polymer may decompose into small molecules and therefore change the original physical and electrical characteristics. In addition, if γ-ray or Cobalt 60 is used for irradiation, it takes much time due to its low energy and thus the throughput is decreased. Although the process time can be significantly reduced if irradiating by electron beams, the high heat generated from rapid cross-linking between molecules bonds will generate internal stresses or gases. Furthermore, if the density of cross-linking is not uniform, internal stresses of the PTC device may be generated also. Consequently, the high voltage endurance of the device becomes insufficient, and sometimes voids and gases are generated caused by localized high heat, with the result that device resistance rapidly ramps up or devices are burned down under high voltage testing. Because the manufacturing process is difficult to control and minor variations could significantly influence device quality, the manufacturing cost for devices is relatively high.

In addition to irradiation, chemical cross-linking can be an alternative, for which peroxides are mixed into the PTC matrix and are decomposed under high temperature to generate free radicals for cross-linking. Preferably, the cross-linking does not occur during manufacture of PTC material, and instead occurs in the PTC material curing process. However, PTC material normally needs to be manufactured at a temperature higher than 150° C., and at such temperature the peroxides start reacting. As a result, PTC material is cured ahead of time and thus cannot be formed, so that chemical cross-linking is difficult to implement in mass production of PTC polymer.

### SUMMARY OF THE INVENTION

The objective of the present invention is to provide an over-current protection device and manufacturing method thereof. Unlike traditional chemical cross-linking, the present invention disclosed a multi-layer stacked structure with inter-layer chemical cross-linking in which chemical functional groups react between layers to generate chemical bonding. Before hot pressing, the functional group of a polymer layer does not contact functional groups of other layers, so that the layer material remains a stable and non-reacted thermoplastic polymer. Accordingly, the manufacturing and storage of PTC material can retain features similar to those of traditional thermoplastic polymer whereby the problem that curing occurs ahead of time in chemical cross-linking process can be avoided and yield loss due to process variances can be decreased. Therefore, an over-current protection device made according to the present invention can be of high voltage endurance.

Also, the manufacturing method of an over-current protection device in accordance with the present invention is different from the traditional method using radiation. The present invention has the follow advantages: (1) because the chemical cross-linking is achieved by hot pressing, no polymer bonding breakage or degradation occurs such as that caused by radiation. Instead, the PTC material layer becomes more stiff due to chemical cross-linking; (2) The time required for chemical cross-linking by hot pressing is much shorter than that for traditional radiation with a high dose, e.g., >50 Mrads, so that the manufacturing speed can be significantly increased; (3) radiation may be sheltered by other objects and thus generate problems related to uneven radiation, which can be completely avoided in accordance with the present invention; (4) Electron beam (E-beam) radiation would generate localized high heat to burn material down, and therefore the process temperature range (<85° C.) during radiation is quite narrow. The material used for the present invention is not limited to its process temperature, and therefore the variation of material quality influenced by process temperature can be reduced tremendously; and (5) Because the uniformity of cross-linking in accordance with the present invention is better than that when performed by radiation, the device made in accordance with the present invention has more uniform current density under high voltage and therefore has better endurance to high voltage.

A laminated over-current protection device disclosed in the present invention comprises a laminated chemically cross-linked PTC material layer and two electrode foils. The laminated chemically cross-linked PTC material layer is formed by hot pressing polymer layers A (first polymer layers) and polymer layers B (second polymer layers), and the polymer layers A and B are interlaced in series. The polymer layers A comprise functional group-X (first functional group); whereas polymer layers B comprise functional group-Y (second functional group). The functional group-X and functional group-Y can generate inter-layer cross-linking. During the pressing process, the functional group-Y of the polymer layers B and the functional group-X of the polymer layers A are reacted through inter-penetration of molecules or bonding between layers so as to induce cross-linking.

The polymer layers A and the polymer layers B may be comprised of polyethylene, polypropylene, polyoxymethylene, poly(ethylene oxide), poly(ethylene terephthalate), polyisobutylene, poly(e-caprolactam), poly(hexamethylene adipamide), poly(vinyl fluoride), poly(vinylidene fluoride), polychlorotrifluoroethylen, polytetrafluoroethylene, (poly(vinyl chloride)), poly(vinylidene chloride), polystyrene, poly(acrylic acid), poly(vinyl acetate), polyacrylate, poly(methyl methacrylate), ionomer, or a co-polymer consisting of the monomers of the above-mentioned polymer. More specifically, the polymer layers A may be selected from grafted or copolymerized epoxide functional group; the polymer layers B may be selected from the group of polyethylene grated or copolymerized maleic anhydride, or polypropylene grated or copolymerized maleic anhydride.

In addition to the above-mentioned polymers, polymer layers A and B further comprise conductive fillers such as carbon black, graphite, metallic powder, ceramic powder and fiber conductive material. The materials after being mixed have a volumetric resistivity between 10⁻² and 10⁵ Ω-cm, and preferably between 10⁻¹ and 10³ Ω-cm. For inter-penetration between layers, the thickness of each layer is between 0.01 and 5 millimeters (mm), and preferably between 0.1 and 1 mm. Thinner layers have better inter-penetration. The polymer layers A and polymer layers B can be individually formed by film extrusion, powder coating or high vacuum sputtering.

The functional group-X in layers A can be combined with polymer in layers A through the following methods: (1) copolymerization: copolymerizing monomers of polymer and monomers containing functional group-X to form polymer backbone including functional group-X; (2) grafting: reacting polymer backbone with monomer containing functional group-X so as to graft the functional group-X to the backbone; and (3) physical combination: by the feature of polymer such as crystallization, packing the molecules having the functional group-X in crystal of polymer and the molecules of the functional group-X are released until the crystals of polymer are melted at high temperature. Likewise, the functional group-Y of the layers B can be combined with the polymer in the layer B by the same method.

To obtain better cross-linking, the temperature and pressure between layers while the layers are being pressed are dependent on the chemical characteristics of cross-linking and the flowability, thickness and melting point of the polymer of the layers. Generally, the hot-pressing is conducted at a temperature of 100 to 250° C. and at a pressure of less than 5,000 psi for 0.1 to 24 hours. The thickness of the chemically cross-linked layer after hot pressing is between 0.1 and 10 mm, and preferably between 0.5 and 5 mm.

The chemical reaction between the functional group-X of the layer A and the functional group-Y of the layer B can be performed through condensation reaction, free radical reaction or acid-base reaction. For instance, epoxide in layer A can be cross-linked with anhydride of layer B through condensation reaction; the un-saturation bond of the layer A can be cross-linked with azodiisobutyronitrile (AIBN) through free radical reaction; and amine of layer A can be cross-linked with anhydride of layer B through acid-base reaction. The functional group-X and functional group-Y could be the new functional group after being altered, i.e., pyrolysis, by external excitation such as temperature, pressure, or electromagnetic wave. Particularly, the functional group-X of layer A is selected from the group consisting of amine, aldehyde, alcohol, epoxide, halogen and un-saturated base such as alkene or alkyne, and the functional group-Y of the layer B is selected from the group consisting of acid, anhydride, peroxy and phenol.

The chemically cross-linked polymeric PTC layer is not limited to alternately laminating different polymer layers A and B, and can be formed by laminating and pressing a plurality of different polymer layers A, B, C, . . . in which different functional groups of different layers are cross-linked. Each layer is thermoplastic before hot-pressing, so polymer layers can be manufactured by traditional extrusion. After hot-pressing, cross-linking occurs at the interfaces between neighboring polymer layers, and the formed cross-linked PTC layer becomes thermoset.

The laminated over-current protection device comprises a chemically cross-linked polymeric PTC layer and two electrode foils. The two electrode foils can be connected to a power source so as to allow current to flow through the chemically cross-linked polymeric PTC layer. U.S. Pat. Nos. 5,227,946, 5,195,013 and 5,140,297 use scanning electron metrology (SEM) to measure voltage endurance, in which the voltage endurance is less than 3 volts every 10 microns in thickness. The PTC device of the present invention also can withstand high voltage; the voltage endurance is less than 30 volts per 0.1 mm in thickness. In other words, for the addition of every 0.1 mm in thickness of PTC layer, 30 volts of voltage endurance can be increased at most. If the chemically cross-linked polymeric PTC layer is thicker, the over-current protection device thereof can withstand higher voltage.

Moreover, in order to improve the high voltage endurance of the chemically cross-linked polymeric PTC layer, chemical cross-linking reaction control agent and modifiers are added while the polymers are blending such as (1) initiator including anionic initiator, e.g., piperidine, phenol and 2-ethyl-4-methyl-imidazole; and cationic initiator, e.g., boron trifluoride, BF3-amine complex, PF5 and trifluoromethanesulfonic acid; (2) catalyst including ammonium salt, e.g., ethyl triphenyl ammonium bromide; phosphonium salt, e.g., triethyl methyl phosphonium acetate; metal alkoxides, e.g., aluminum isopropoxide and latent; catalyst, e.g., crystalline amine, core-shell polymer with amine core, high dissociation temperature peroxide and azo compound; (3) dispersion agent including polyethylene wax, stearic acid, zinc stearate and low molecular weight acrylate copolymer; (4) coupling agent including aminosilane, epoxysilane, mercaptosilane; (5) flame retardant including halogen or phosphor flame retardant compositions, metallic hydroxide, e.g., Al₂(OH)₃, Mg(OH)₂, metallic oxide, e.g., ZnO and Sb₂O₃; (6) plasticizer including dibasic ester, e.g., dimethyl succinate, dibutyl phthalate, dimethyl glutarate and dimethyl adipate; and (7) organic or inorganic filler including fluoride polymer powder, talc, kaolin and SiO₂; and (8) antioxidant, e.g., pentaerythrityl-tetrakis [3-(3,5-di-tertbutyl-4-hydroxy-phenyl)-propionate].

After hot-pressing, the chemically cross-linked polymeric PTC layer could be further subjected to a heat treatment under a temperature less than 270° C. for 1 to 48 hours. The temperature of heat treatment depends upon the reaction temperature of the functional groups X and Y, and is generally higher than that of the hot pressing to increase the chemical cross-linking.

Moreover, a non-crosslink polymer layer can serve as an interface between the electrode foil and the chemically cross-linked polymeric PTC layer, or polymer layers of different chemical functional groups, thereby improving the combination of layers and ease of production because the non-crosslink polymer layer has better thermoplastic behavior.

### BRIEF DESCRIPTION OF THE DRAWINGS

FIGS. 1 and 2 illustrate an over-current protection device and the manufacturing method thereof in accordance with the present invention.

### DETAILED DESCRIPTION OF THE INVENTION

A chemically cross-linked polymeric PTC layer formed by chemically reacting a polymer layer A including functional group-X and a polymer layer B or C including functional group-Y is exemplified as follows, so as to illustrate a laminated over-current protection device including a chemically cross-linked polymeric PTC layer in accordance with the present invention. Table 1 shows the ingredients of polymer layers, in which carbon black serves as conductive filler specified as RAVEN 430 ULTRA of Columbian Chemical Company, the polymer matrix includes (1) high density polyethylene (HDPE), using PE8010 of Formosa Plastic Company; (2) polyethylene grated 8 wt % glycidylmethacrylate (GMA) including epoxide, using Lotader AX8840 of ATOFINA; (3) copolymer of 6.5 wt % acrylic acid (AA) and ethylene, using Primaco 3340 of Dow Chemical; and (4) ethylene grated polymer of 0.9 wt % maleic anhydride (MA), using MB 100D of Dupont.

TABLE 1

| | Ingredient (wt %) | | | | | |
|---|---|---|---|---|---|---|
| | | GMA- | | MA- | | |
| Polymer | Carbon | poly- | AA-poly- | poly- | | |
| layer | black | ethylene | ethylene | ethylene | HDPE | Mg(OH)₂ |
| Layer A | 36 | 8 | — | — | 35 | 21 |
| Layer B | 36 | — | 8 | — | 35 | 21 |
| Layer C | 36 | — | — | 5 | 38 | 21 |
| compare | 36 | — | — | — | 43 | 21 |
| example | | | | | | |

Layer A is fabricated by blending the materials according to Table 1 in a twin screw blender made by HAAKE. The materials are pre-mixed for 1.5 minutes, and blended for 15 minutes at 150° C. The conductive polymer of Layer A after blending is pressed by a hot-presser at a temperature of 180° C. and a pressure of 150 kg/cm² to be a thin plate having a thickness of approximately 0.12 mm, and then the plate is cut into square pieces of 20 cm×20 cm each.

Layer B is fabricated in a manner similar to Layer A, materials shown in Table 1 are put in the HAAKE twin screw blender, with the further addition of 500 ppm of ethyltriphenylphosphoniumbromide. These materials are pre-mixed for 1.5 minutes, and blended for 15 minutes at 150° C. The conductive polymer of Layer B after blending is pressed by a hot-presser at a temperature of 160° C. and a pressure of 150 kg/cm² to be a thin plate having a thickness of approximately 0.12 mm, and the plate is then cut into square pieces of 20 cm×20 cm each.

Layer C is fabricated in a manner similar to Layer A. Materials shown in Table 1 are disposed in the HAAKE twin screw blender, pre-mixed for 1.5 minutes, and blended for 10 minutes at 150° C. The conductive polymer of Layer C after blending is pressed by a hot-presser at a temperature of 160° C. and a pressure of 150 kg/cm² to be a thin plate having a thickness of approximately 0.12 mm. The plate is then cut into square pieces of 20 cm×20 cm each.

### EXAMPLE 1

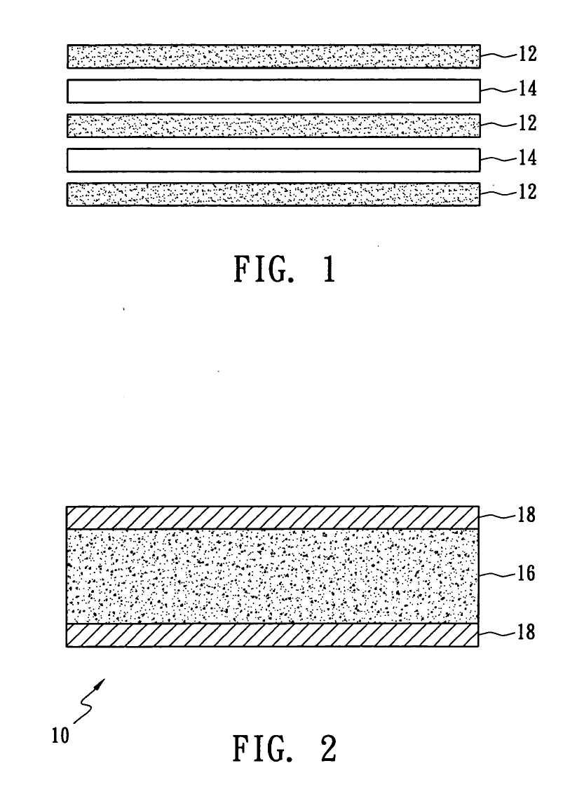

As shown in FIG. 1, layers 12 (Layer A) and layers 14 (Layer B) are alternately stacked in a multi-plate arrangement according to the sequence A-B-A-B- . . . , and two electrode foils 18, e.g., nickel foils, are adhered to upper and lower surfaces of the multi-plate at 200° C. and 150 kg/cm² by a hot presser. Layers 12 and 14 are chemically cross-linked through hot pressing for 30 minutes, so as to form a chemically cross-linked polymeric PTC layer 16, which is then cooled to room temperature. The chemically cross-linked polymeric PTC layer 16 has a thickness of 3.6 mm, and is cut to be PTC devices 10 as shown in FIG. 2 by diamond knife. The PTC device 10 has an area of 7.9 mm×12.4 mm, and includes the chemically cross-linked polymeric PTC layer 16 made of conductive polymer and the upper and lower electrode foils 18 (nickel foils). Then, the chemically cross-linked PTC device 10 is subjected to heat treatment at 150° C. for 10 hours to increase the extent of the cross-linking. The chemically cross-linked PTC device 10 after heat treatment can pass the high voltage endurance test under 600V/1 A/1 sec.

### EXAMPLE 2

As shown in FIG. 1, layers 12 (Layer A) and layers 14 (Layer C) are alternately stacked in a multi-plate arrangement according to the sequence A-C-A-C- . . . , and two electrode foils 18, e.g., nickel foils, are adhered to upper and lower surfaces of the multi-plate at 200° C. and 150 kg/cm² by a hot presser. Layers 12 and 14 are chemically cross-linked through hot pressing for 30 minutes, so as to form a chemically cross-linked polymeric PTC layer 16, which is then cooled to room temperature. The chemically cross-linked polymeric PTC layer 16 has a thickness of 3.6 mm, and is cut to be PTC devices 10 as shown in FIG. 2 by diamond knife. The PTC device 10 has an area of 7.9 mm×12.4 mm, and includes the chemically cross-linked polymeric PTC layer 16 made of conductive polymer and the upper and lower electrode foils 18 (nickel foils). Then, the chemically cross-linked PTC device 10 is subjected to heat treatment at 150° C. for 10 hours. The chemically cross-linked PTC device 10 after heat treatment can pass the high voltage endurance test at 600V/1 A/1 sec.

### COMPARISON EXAMPLE

Materials shown in Table 1 are disposed in the HAAKE twin screw blender, and are pre-mixed 1.5 minutes, and blended for 15 minutes at 150° C. The conductive polymer after blending is hot pressed at a temperature of 160° C. and a pressure of 150 kg/cm² to form a plaque without chemical cross-linking and having a thickness of approximately 0.12 mm. Then, the plaque is cut into square pieces of 20 cm 30×20 cm. Two electrode foils 18, e.g., nickel foils, are adhered to upper and lower surfaces of the plaque via hot press lamination at 200° C. and 150 kg/cm² for 30 minutes with consecutive cooling to room temperature, so as to form a non-cross-linking PTC laminate. The PTC laminate has a thickness of 3.6 mm, and is cut to prepare a PTC devices 10 by diamond knife. The PTC device 10 has an area of 7.9 mm×12.4 mm, and includes the PTC layer made of the conductive polymer and the upper and lower electrode foils (nickel foils). Then, the PTC device 10 is subjected to a heat treatment at 150° C. for 10 hours. The non-cross-linking PTC device after heat treatment fails to pass the high voltage endurance test of 600V/1 A/1 sec.

The functional group of the polymer of Layer A includes amine, aldehyde, alcohol, epoxide, halogen, or unsaturated group such as alkene or alkyne, whereas the functional group of the polymer of Layer B includes acid, anhydride and phenol; such materials can enable cross-linking.

From the above experiments, the device having chemically cross-linked polymeric PTC layer (Examples 1 and 2), in comparison with the device without chemical cross-linking, can significantly improve the endurance of high voltage.

In brief, the polymer layer A (Layer 12) and polymer layer B (Layer 14) are hot pressed at a temperature between 150 and 200° C. to generate chemical cross-linking, so as to form a chemically cross-linked polymeric PTC layer 16. The PTC layer 16 can be in connection with an upper electrode foil and a lower electrode foil 18 to form an over-current protection device 10 as shown in FIG. 2.

The above-mentioned over-current protection device including chemically cross-linked polymeric PTC layer can withstand high voltage. If the electrode foils of the over-current protection device are connected to a power source, the potential difference of every 0.1 mm in thickness of the chemically cross-linked polymeric PTC layer is less than 30 volts. In other words, every 0.1 mm in thickness of the chemically cross-linked polymeric PTC layer can withstand a voltage up to approximately 30 volts. Thicker chemically cross-linked polymeric PTC layers can withstand higher voltage.

The above-described embodiments of the present invention are intended to be illustrative only. Numerous alternative embodiments may be devised by those skilled in the art without departing from the scope of the following claims.

What is claimed is:

1. An over-current protection device, comprising:
a laminated chemically cross-linked polymeric positive temperature coefficient (PTC) layer including a plurality of PTC layers which are alternately laminated in series connection and hot pressed to generate chemical cross-linking therebetween; and
two electrode foils respectively and physically in contact with an upper surface and a lower surface of the laminated chemically cross-linked polymeric PTC layer for connection to a power source so as to allow current to flow through the laminated chemically cross-linked polymeric PTC layer;
wherein the potential difference of every 0.1 mm in thickness of the laminated chemically cross-linked polymeric PTC layer is less than 30 volts.

2. The over-current protection device of claim 1, wherein the plurality of PTC polymer layers comprises a first polymer layer and a second polymer layer, the first polymer layer including a first functional group, and the second polymer layer including a second functional group, wherein the first functional group and the second functional group are reacted to form chemical cross-linking while the first and second functional groups are laminated alternately and hot pressed.

3. The over-current protection device of claim 2, wherein the first polymer layer and the second polymer layer include polymer and conductive filler, and are of a volumetric resistance between 10⁻¹ and 10³ Ω-cm.

4. The over-current protection device of claim 2, wherein the first polymer layer and the second polymer layer are layers of thermoplastic polymer.

5. The over-current protection device of claim 1, wherein the laminated chemically cross-linked polymeric PTC layer is a layer of thermoset polymer.

6. The over-current protection device of claim 2, wherein the first functional group is selected from the group consisting of amine, aldehyde, alcohol, epoxide and halogen.

7. The over-current protection device of claim 2, wherein the second functional group is selected from the group consisting of acid, anhydride and phenol.

8. The over-current protection device of claim 2, wherein the first polymer layer includes polymer containing grafted or copolymerized epoxide functional group.

9. The over-current protection device of claim 2, wherein the second polymer layer includes polyethylene grated or copolymerized maleic anhydride, or polypropylene grated or copolymerized maleic anhydride.

10. The over-current protection device of claim 2, wherein each of the first and second polymer layers is of a thickness between 0.1 and 1 mm.

11. The over-current protection device of claim 1, wherein the laminated chemically cross-linked polymeric PTC layer is of a thickness between 0.5 and 5 mm.

12. The over-current protection device of claim 3, wherein the conductive filler is carbon black.

13. A manufacturing method for an over-current protection device, comprising the steps of:
Stacking alternately at least two PTC polymer layers in series connection, wherein each PTC polymer layer comprises polymer and conductive filler and is of a volumetric resistance between 10⁻¹ and 10³ Ω-cm, and the two PTC polymer layers include different functional groups;
Connecting two electrode foils to an upper surface and a lower surface of the stacked PTC polymer layers; and
hot-pressing the two electrode foils and the stacked PTC polymer layer to generate chemical reaction between the different functional groups of neighboring PTC polymer layers, so as to form a chemically cross-linked polymeric PTC layer in physical contact with the two electrode foils, wherein the potential difference of every 0.1 mm in thickness of the chemically cross-linked polymeric PTC layer is less than 30 volts.

14. The manufacturing method for an over-current protection device of claim 13, wherein the functional groups are selected from the group consisting of amine, aldehyde, alcohol, epoxide, halogen, acid, anhydride and phenol.

15. The manufacturing method for an over-current protection device of claim 13, wherein the PTC polymer layers are manufactured through extrusion.

16. The manufacturing method for an over-current protection device of claim 13, wherein the hot-pressing is conducted at a temperature between 100 and 250° C. and a pressure less than 5,000 psi for 0.1 to 24 hours.

17. The manufacturing method for an over-current protection device of claim 13, further comprising a heat treatment under a temperature less than 270° C. for 1 to 48 hours.
